(19) United States
(12) Patent Application Publication
(10) Pub. No.: US 2026/0014834 A1
(43) Pub. Date: Jan. 15, 2026

(54) IN-VEHICLE AIR CONDITIONING DEVICE

(71) Applicant: TOYOTA JIDOSHA KABUSHIKI KAISHA, Aichi-ken (JP)

(72) Inventors: Yohei KOIKE, Toyota-shi (JP); Jun KOKAJI, Toyota-shi (JP)

(21) Appl. No.: 19/239,970

(22) Filed: Jun. 17, 2025

(30) Foreign Application Priority Data
Jul. 12, 2024 (JP) 2024-112303

(51) Int. Cl. B60H 1/32; F25B 49/02

(52) U.S. Cl. CPC B60H 1/3216; B60H 1/3223; F25B 49/022; F25B 2700/17; F25B 2700/2105

(57) ABSTRACT

An in-vehicle air conditioning device includes a refrigerant circuit and a controller. The refrigerant circuit includes an electric compressor, a condenser, an expansion valve, and an evaporator. A refrigerant circulates through the refrigerant circuit. The refrigerant circuit includes a pipe which is connected to the electric compressor and through which the refrigerant discharged from the electric compressor flows. The controller calculates a pulsation frequency of pulsation generated in the pipe based on a target rotational speed for the electric compressor based on an air conditioning request. The controller calculates an air column resonance frequency of the pipe based on a sonic speed of the refrigerant and a length of the pipe. When the pulsation frequency is within a predetermined frequency band including the air column resonance frequency, the controller updates the target rotational speed for the electric compressor so as to avoid the pulsation frequency being within the frequency band.

### CROSS-REFERENCE TO RELATED APPLICATION

This application claims priority to Japanese Patent Application No. 2024-112303 filed on Jul. 12, 2024, incorporated herein by reference in its entirety.

### BACKGROUND

### 1. Technical Field

The present specification relates to an in-vehicle air conditioning device, and in particular to control of the rotational speed of an electric compressor that compresses and discharges a refrigerant.

### 2. Description of Related Art

A vehicle is equipped with an air conditioning device. The air conditioning device includes a refrigerant circuit which includes an electric compressor, a condenser, an expansion valve, and an evaporator, and through which a refrigerant circulates. The air conditioning device blows air through the evaporator using a blower, and sends the cooled air into a vehicle cabin.

The refrigerant circuit includes a pipe which is connected to the electric compressor and through which the refrigerant discharged from the electric compressor flows. The electric compressor sucks in the refrigerant by the rotation of a motor, compresses the refrigerant, and discharges the refrigerant into the pipe. The pipe is vibrated by the refrigerant discharged from the electric compressor, and therefore a technique of suppressing such vibration is being studied.

Japanese Unexamined Patent Application Publication No. 2016-23780 (JP 2016-23780 A) discloses a technique of reducing compressor pulsation of a compressor colliding against a wall surface of a bent portion in a pipe between a condenser and the compressor in a refrigerant circuit of an in-vehicle air conditioning device, by providing the bent portion at a position that is an integer multiple of half the wavelength of the compressor pulsation away from the condenser.

### SUMMARY

The electric compressor is a pump. When the electric compressor is driven, pulsation in the flow rate of the refrigerant is generated in the pipe through which the refrigerant discharged from the electric compressor flows. Accordingly, pressure pulsation due to the pulsation in the flow rate is generated in the pipe. When the rotational speed of the motor of the electric compressor is N [rpm], the frequency (referred to as a “pulsation frequency”) of the pressure pulsation is f1 [Hz]=N/60 (fundamental order).

On the other hand, the pipe has an air column resonance frequency f2 [Hz]. The air column resonance frequency is determined based on the sonic speed of the refrigerant in the pipe and the length of the pipe.

When the pulsation frequency f1 coincides with the air column resonance frequency f2 or is close to the air column resonance frequency f2, the pressure pulsation in the pipe may be amplified, causing the pipe to vibrate significantly. Thus, it is desired to suppress the pulsation frequency of the electric compressor being close to the air column resonance frequency of the pipe.

The present specification discloses an in-vehicle air conditioning device that suppresses the pulsation frequency of an electric compressor being close to the air column resonance frequency of a pipe.

An aspect of the present specification discloses an in-vehicle air conditioning device including: a refrigerant circuit which includes an electric compressor, a condenser, an expansion valve, and an evaporator and through which a refrigerant circulates; and a controller. The refrigerant circuit includes a pipe which is connected to the electric compressor and through which the refrigerant discharged from the electric compressor flows. The controller is configured to calculate a pulsation frequency of pulsation generated in the pipe based on a target rotational speed for the electric compressor based on an air conditioning request, calculate an air column resonance frequency of the pipe based on a sonic speed of the refrigerant and a length of the pipe, and when the pulsation frequency coincides with the air column resonance frequency or is within a predetermined frequency band including the air column resonance frequency, update the target rotational speed for the electric compressor so as to avoid the pulsation frequency coinciding with the air column resonance frequency or being within the frequency band.

The in-vehicle air conditioning device according to the aspect of the present disclosure may further include a temperature sensor that detects a refrigerant temperature of the refrigerant in the pipe, and the controller may calculate the sonic speed of the refrigerant based on the refrigerant temperature detected by the temperature sensor.

In the in-vehicle air conditioning device according to the aspect of the present disclosure, the electric compressor may be a scroll pump.

Another aspect of the present specification discloses an in-vehicle air conditioning device including: a refrigerant circuit which includes an electric compressor, a condenser, an expansion valve, and an evaporator and through which a refrigerant circulates; and a controller. The refrigerant circuit includes a pipe which is connected to the electric compressor and through which the refrigerant discharged from the electric compressor flows. The controller is configured to calculate a pulsation frequency of pulsation generated in the pipe based on an actual rotational speed of the electric compressor, calculate an air column resonance frequency of the pipe based on a sonic speed of the refrigerant and a length of the pipe, and when the pulsation frequency coincides with the air column resonance frequency or is within a predetermined frequency band including the air column resonance frequency, update the target rotational speed for the electric compressor based on an air conditioning request so as to avoid the pulsation frequency coinciding with the air column resonance frequency or being within the frequency band.

According to the technique disclosed in the present specification, it is possible to suppress the pulsation frequency of an electric compressor being close to the air column resonance frequency of a pipe.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating the configuration of an air conditioning device;

FIG. 2A is a schematic diagram for explaining vibration of a pipe;

FIG. 2B is a schematic diagram for explaining vibration of the pipe;

FIG. 2C is a schematic diagram for explaining vibration of the pipe;

FIG. 3 is a flowchart illustrating the flow of a process according to an embodiment;

FIG. 4 is a timing chart illustrating an example of variations in pulsation frequency and air column resonance frequency; and

FIG. 5 is a flowchart illustrating the flow of a process according to another embodiment.

### DETAILED DESCRIPTION OF EMBODIMENTS

An embodiment will be described below with reference to the drawings. In all drawings, equivalent elements are given the same reference numerals and redundant descriptions are omitted.

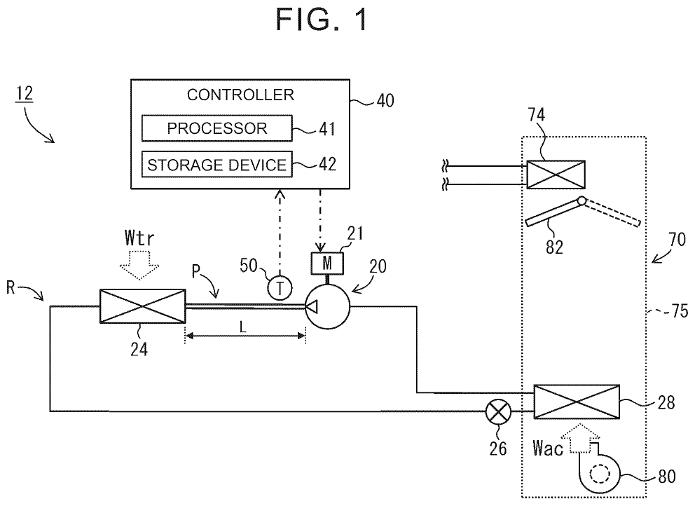

FIG. 1 is a schematic diagram illustrating the configuration of an air conditioning device 12 according to an embodiment. The air conditioning device 12 is mounted on a vehicle such as an automobile. The air conditioning device 12 performs air conditioning in a cabin of the vehicle. As illustrated in FIG. 1, the air conditioning device 12 includes a refrigerant circuit R that serves as a heat source.

The refrigerant circuit R is a closed circuit including an electric compressor 20, a condenser 24, an expansion valve 26, and an evaporator 28, arranged in this order along the flow direction of a refrigerant and connected in sequence by piping. A refrigerant circulates in the refrigerant circuit R. A receiver may be provided between the condenser 24 and the expansion valve 26. In addition, an accumulator may be provided between the evaporator 28 and the electric compressor 20.

The electric compressor 20 is a scroll pump. The electric compressor 20 includes a motor 21, and sucks in the refrigerant by the rotation of the motor 21, compresses the refrigerant, and discharges the refrigerant into a pipe P. While the pipe P between the electric compressor 20 and the condenser 24 is depicted with a double line in an exaggerated manner in FIG. 1, the pipe P is the same as pipes between the other devices. The condenser 24 is a heat exchanger that exchanges heat between the refrigerant and a vehicle head wind Wtr. The evaporator 28 is a heat exchanger disposed in an air passage 75 of an air conditioning unit 70 to exchange heat between the refrigerant and an air conditioning wind Wac. The evaporator 28 cools the air conditioning wind Wac.

In the refrigerant circuit R, the refrigerant circulates as follows. The electric compressor 20 discharges a high-pressure gas refrigerant, and the gas refrigerant is liquefied and condensed by releasing heat through heat exchange with the vehicle head wind Wtr in the condenser 24, becoming a high-pressure liquid refrigerant. The high-pressure liquid refrigerant flowing out of the condenser 24 is depressurized and expanded by the expansion valve 26 to become a low-pressure refrigerant, and flows into the evaporator 28. The low-pressure refrigerant flowing into the evaporator 28 is evaporated through heat exchange with the air conditioning wind Wac in the evaporator 28, flows out of the evaporator 28 as a gas refrigerant, and returns to the electric compressor 20.

The air conditioning device 12 includes an air conditioning unit 70 that supplies air cooled by the evaporator 28 into the vehicle cabin. The air conditioning unit 70 includes a blower 80 and an air passage 75 formed by a case (not illustrated). The blower 80, the evaporator 28, and a heater core 74 are disposed inside the air passage 75 in this order in the air flow direction. The heater core 74 is a heat exchanger to which an engine coolant or a coolant warmed by a water-heating positive temperature coefficient (PTC) heater is 15 supplied, for example. The heater core 74 may be configured to be supplied with a coolant warmed by the condenser 24.

The blower 80 blows temperature-controlled air into the vehicle cabin by introducing air into the air passage 75 from an intake port (not illustrated) and passing the air through the evaporator 28 and the heater core 74. An air mix door 82 is provided inside the air passage 75. The air mix door 82 adjusts the proportion of the air passing through the evaporator 28 to flow to the heater core 74. The air conditioning unit 70 may employ a conventional heating, ventilation, and air conditioning (HVAC) technology.

The air conditioning device 12 includes a controller 40. The controller 40 includes a processor 41 and a storage device 42. The processor 41 performs various calculations and controls by performing processing according to programs stored in the storage device 42. The controller 40 may be an electronic control unit (ECU) having a microcomputer, for example.

The controller 40 sets an air conditioning request based on detection information from a plurality of sensors (not illustrated) that detects outside temperature, inside temperature, solar radiation amount, pressure, etc., and setting information from an operation panel (not illustrated) operated by a user, etc. The air conditioning request is the output level of the air conditioning device 12, and includes a cooling level that indicates the strength of cooling, for example. The controller 40 controls various devices included in the air conditioning device 12 based on the air conditioning request. The controller 40 may employ a conventional technology of controlling an air conditioning device.

As illustrated in FIG. 1, the refrigerant circuit R includes the pipe P which is connected to the electric compressor 20 and through which the refrigerant discharged from the electric compressor 20 flows. The pipe P is the pipe between the electric compressor 20 and the condenser 24. The air conditioning device 12 includes a temperature sensor 50 that detects the temperature of the refrigerant in the pipe P. As discussed later, the controller 40 calculates the sonic speed of the refrigerant based on the refrigerant temperature detected by the temperature sensor 50, in order to acquire the air column resonance frequency of the pipe P.

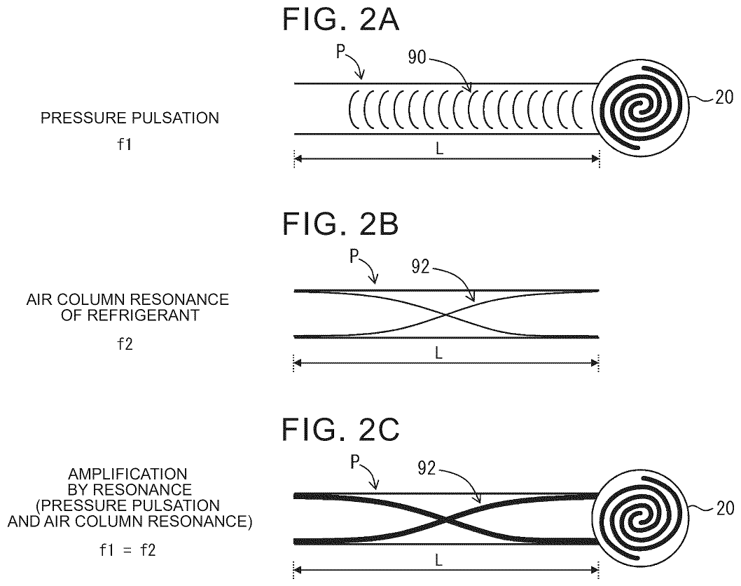

FIGS. 2A, 2B, and 2C are each a schematic diagram for explaining vibration of the pipe P. As illustrated in FIG. 2A, when the electric compressor 20 is driven, pressure pulsation 90 of the refrigerant is generated in the pipe P. The electric compressor 20 is a scroll pump as described above, and discharges the refrigerant once when the motor 21 (see FIG. 1) makes one rotation. When the rotational speed of the motor 21 of the electric compressor 20 is N [rpm], the pulsation frequency of the pressure pulsation is f1 [Hz]=N/60 (fundamental order).

The pipe P has an air column resonance frequency f2 [Hz]. FIG. 2B illustrates a standing wave 92 with ½ wavelength as an example of a standing wave 92 that represents natural vibration of an air column. The shape pattern of the standing wave 92 varies according to the shape (boundary conditions) of both ends of the pipe P. When both ends of the pipe P are open ends, both ends of the pipe P serve as antinodes of the standing wave 92, and a standing wave with fundamental vibration of ½ wavelength appears in the pipe P, as illustrated in FIG. 2B.

For a standing wave with fundamental vibration of ½ wavelength, the air column resonance frequency f2 is represented by the following formula (1).

f2=(c/2L)×m formula (1)

In the above formula (1), c is the sonic speed of the refrigerant, L is the length of the pipe P, and m is the order (an integer of 1 or more that indicates how many times the vibration is greater than the fundamental vibration). The sonic speed c of the refrigerant varies according to the type and the temperature of the refrigerant.

When the pulsation frequency f1 (FIG. 2A) of the pressure pulsation coincides with the air column resonance frequency f2 (FIG. 2B) or is close to the air column resonance frequency f2, the vibration of the pipe P is amplified, causing the pipe P to vibrate significantly, as illustrated in FIG. 2C.

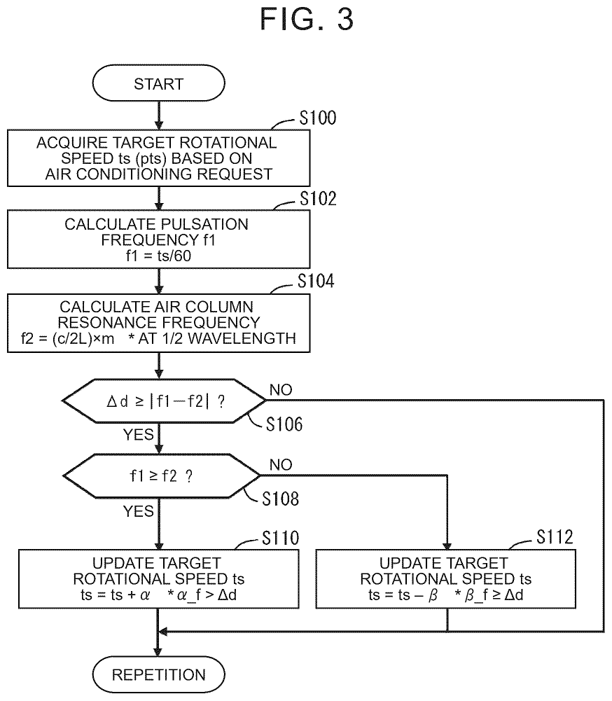

Thus, when the pulsation frequency f1 coincides with the air column resonance frequency f2 or is within a predetermined frequency band including the air column resonance frequency f2, the controller 40 updates the target rotational speed for the electric compressor 20 so as to avoid the pulsation frequency f1 coinciding with the air column resonance frequency f2 or being within the frequency band. The specific process is indicated in FIG. 3.

FIG. 3 is a flowchart illustrating the flow of a process according to the embodiment. The controller 40 executes the process flow in FIG. 3 in cycles determined in advance.

In step S100, the controller 40 sets a target rotational speed ts [rpm] for the electric compressor 20 based on an air conditioning request. In the following description, the target rotational speed set based on the air conditioning request is occasionally indicated as “pts”.

In step S102, the controller 40 calculates a pulsation frequency f1 [Hz]. f1 is calculated as ts/60.

In step S104, the controller 40 calculates an air column resonance frequency f2 using the above formula (1). The length L of the pipe and the order m in the formula (1) can be stored in advance in the storage device 42 of the controller 40. The sonic speed c of the refrigerant is calculated using a calculation formula f(T) that includes, as a variable, a temperature T corresponding to the refrigerant used in the refrigerant circuit R. The calculation formula f(T) is stored in advance in the storage device 42 of the controller 40. The controller 40 calculates a sonic speed c by acquiring a refrigerant temperature T from the temperature sensor 50 and substituting the refrigerant temperature T into the calculation formula f(T).

The sonic speed c of the refrigerant may be acquired using a table that associates the temperature T and the sonic speed c corresponding to the refrigerant used in the refrigerant circuit R. In this case, the table is stored in advance in the storage device 42 of the controller 40. The controller 40 acquires a refrigerant temperature T from the temperature sensor 50, and acquires a sonic speed c corresponding to the refrigerant temperature T from the table.

In step S106, the controller 40 checks whether the pulsation frequency f1 is within a predetermined frequency band (f2−Δd) to (f2+Δd) including the air column resonance frequency f2. In other words, it is checked whether the air column resonance frequency f2 is within a predetermined frequency band (f1−Δd) to (f1+Δd) including the pulsation frequency f1. Δd is a frequency width determined in advance, and is stored in advance in the storage device 42 of the controller 40.

Specifically, in step S106, the controller 40 checks whether |f1−f2| (absolute value of (f1−f2)) is equal to or less than Δd. When Δd≥|f1−f2| is not met (S106: No), that is, when Δd<|f1−f2| is met, the controller 40 determines that the pulsation frequency f1 is not within the predetermined frequency band including the air column resonance frequency f2, and ends the process flow in FIG. 3. In this case, the controller 40 controls the motor 21 of the electric compressor 20 such that the actual rotational speed of the motor 21 is brought to the target rotational speed pts [rpm] (the target rotational speed set in step S100).

When Δd≥|f1−f2| is met (S106: Yes), on the other hand, the controller 40 determines that the pulsation frequency f1 is within the predetermined frequency band including the air column resonance frequency f2, and proceeds to step S108.

In step S108, the controller 40 checks whether the pulsation frequency f1 is equal to or higher than the air column resonance frequency f2 (f1≥f2). When f1 is equal to or higher than f2 (S108: Yes), the controller 40 updates the target rotational speed ts by adding a rotational speed α (a positive value) determined in advance to the target rotational speed ts in step S110. The rotational speed α determined in advance is stored in advance in the storage device 42 of the controller 40. When the rotational speed α [rpm] determined in advance per second is represented as α_f (=α/60), the value of a is preferably set so as to meet the condition α_f>Δd.

When f1≥f2 is not met in S108 (S108: No), that is, when f1<f2 is met, on the other hand, the controller 40 updates the target rotational speed ts by subtracting a rotational speed β (a positive value) determined in advance from the target rotational speed ts in step S112. The rotational speed β determined in advance is stored in advance in the storage device 42 of the controller 40. When the rotational speed β [rpm] determined in advance per second is represented as β_f (=β/60), the value of β is preferably set so as to meet the condition β_f≥Δd.

When the target rotational speed ts is updated in step S110 or step S112, the controller 40 controls the motor 21 of the electric compressor 20 such that the actual rotational speed of the motor 21 is brought to the updated target rotational speed ts [rpm].

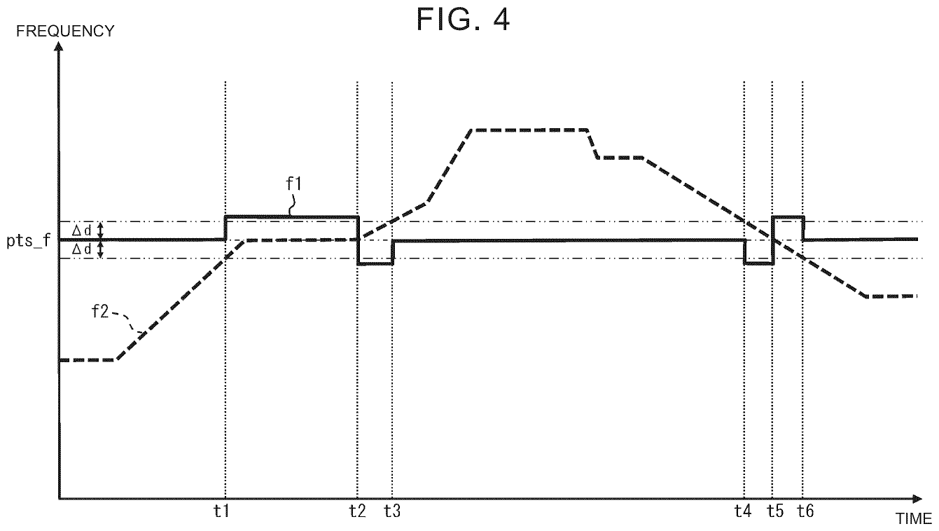

FIG. 4 is a timing chart illustrating an example of variations in the pulsation frequency f1 and the air column resonance frequency f2 at the time when the process flow in FIG. 3 is executed. In the drawing, pts_f [Hz] is the value of 1/60 of the target rotational speed pts [rpm] (S100 in FIG. 3) set based on the air conditioning request. The pulsation frequency f1 [Hz] is the value of 1/60 of the target rotational speed ts [rpm].

FIG. 4 illustrates an example in which the air column resonance frequency f2 varies due to variations in the refrigerant temperature when the target rotational speed pts (pts_f) for the electric compressor 20 based on the air conditioning request is constant.

In FIG. 4, before time t1, the air column resonance frequency f2 and the target rotational speed pts_f are far apart, and thus the target rotational speed ts (pulsation frequency f1) is not updated (S106: No in FIG. 3).

At time t1, the air column resonance frequency f2 is close to the target rotational speed pts_f (S106: Yes), and thus the target rotational speed ts (pulsation frequency f1) is increased (S108: Yes, S110 in FIG. 3) to avoid the pulsation frequency f1 being close to the air column resonance frequency f2.

At time t2, the air column resonance frequency f2 becomes greater than the target rotational speed pts_f (S108: No), and thus the target rotational speed ts (pulsation frequency f1) is reduced (S112 in FIG. 3) to prevent the pulsation frequency f1 being close to the air column resonance frequency f2.

At time t3, the air column resonance frequency f2 is significantly apart from the target rotational speed pts_f (S106: No in FIG. 3), and thus the target rotational speed ts (pulsation frequency f1) is returned to the target rotational speed pts (pts_f) based on the air conditioning request.

Furthermore, at time t4, the air column resonance frequency f2 is close to the target rotational speed pts_f again (S106: Yes), and thus the target rotational speed ts (pulsation frequency f1) is reduced (S108: No, S112 in FIG. 3) to prevent the pulsation frequency f1 being close to the air column resonance frequency f2. The same avoiding process and target rotational speed returning process as those described above are performed at times t5 and t6, although not described in detail in order to avoid repetition.

According to the embodiment described above, it is possible to suppress the pulsation frequency f1 of the electric compressor 20 being close to the air column resonance frequency f2 of the pipe P. Therefore, it is possible to suppress the amplification of vibration of the pipe P, and suppress the transmission of vibration noise of the pipe P to the interior of the cabin of the vehicle.

In the embodiment described above, the target rotational speed ts is increased or decreased as indicated in steps S110 and S112 in FIG. 3, in order to shift the target rotational speed ts (pulsation frequency f1) from the air column resonance frequency f2. However, the target rotational speed ts may be shifted from the air column resonance frequency f2 without decreasing the target rotational speed ts, that is, by increasing the target rotational speed ts at all times. In this case, ts=ts+γ is used instead of ts=ts−β in the process in step S112 in FIG. 3. That is, in step S112, the controller 40 updates the target rotational speed ts by adding a rotational speed γ (a positive value) determined in advance to the target rotational speed ts. The rotational speed γ determined in advance is stored in advance in the storage device 42 of the controller 40. When the rotational speed γ [rpm] determined in advance per second is represented as γ_f (=γ/60), the value of γ is preferably set so as to meet the condition γ_f>(Δd+(f2−f1)).

In the embodiment described above, the sonic speed c of the refrigerant is calculated from the refrigerant temperature T detected using the temperature sensor 50. However, the temperature sensor 50 may be omitted when the value or the range of the value of the refrigerant temperature T during operation of the electric compressor 20 can be known in advance, for example.

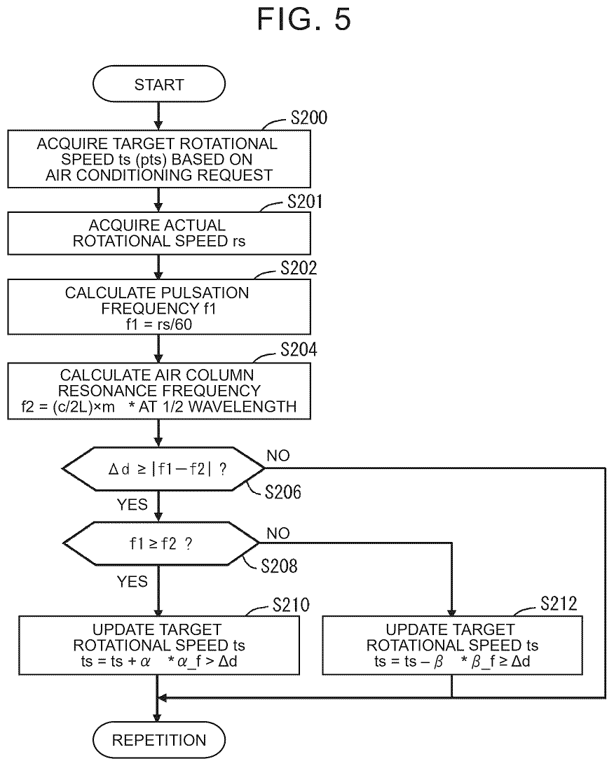

FIG. 5 is a flowchart illustrating the flow of a process according to another embodiment. Steps S200 and S204 to S212 in FIG. 5 are the same processes as steps S100 and S104 to S112 in FIG. 3. In the process flow in FIG. 5, step S201 is added, and the process in step S202 is changed from step S102 in FIG. 3.

Specifically, in step S201, the controller 40 acquires an actual rotational speed rs [rpm] of the motor 21 of the electric compressor 20. In this embodiment, the air conditioning device 12 is provided with a rotational speed sensor that detects the actual rotational speed rs of the motor 21. The controller 40 acquires the actual rotational speed rs [rpm] of the motor 21 from the rotational speed sensor.

Then, in step S202, the controller 40 calculates a pulsation frequency f1 [Hz] from the actual rotational speed rs of the motor 21. f1 is calculated as rs/60.

According to this embodiment, the pulsation frequency f1 can be acquired accurately when the actual rotational speed of the motor 21 deviates relatively significantly from the target rotational speed. Consequently, it is possible to appropriately suppress the pulsation frequency f1 of the electric compressor 20 being close to the air column resonance frequency f2 of the pipe P.

What is claimed is:

1. An in-vehicle air conditioning device comprising:
a refrigerant circuit which includes an electric compressor, a condenser, an expansion valve, and an evaporator and through which a refrigerant circulates; and
a controller, wherein:
the refrigerant circuit includes a pipe which is connected to the electric compressor and through which the refrigerant discharged from the electric compressor flows; and
the controller is configured to
calculate a pulsation frequency of pulsation generated in the pipe based on a target rotational speed for the electric compressor based on an air conditioning request,
calculate an air column resonance frequency of the pipe based on a sonic speed of the refrigerant and a length of the pipe, and
when the pulsation frequency coincides with the air column resonance frequency or is within a predetermined frequency band including the air column resonance frequency, update the target rotational speed for the electric compressor so as to avoid the pulsation frequency coinciding with the air column resonance frequency or being within the frequency band.

2. The in-vehicle air conditioning device according to claim 1, further comprising a temperature sensor that detects a refrigerant temperature of the refrigerant in the pipe, wherein the controller calculates the sonic speed of the refrigerant based on the refrigerant temperature detected by the temperature sensor.

3. The in-vehicle air conditioning device according to claim 1, wherein the electric compressor is a scroll pump.

4. An in-vehicle air conditioning device comprising:
a refrigerant circuit which includes an electric compressor, a condenser, an expansion valve, and an evaporator and through which a refrigerant circulates; and
a controller, wherein:
the refrigerant circuit includes a pipe which is connected to the electric compressor and through which the refrigerant discharged from the electric compressor flows; and
the controller is configured to
calculate a pulsation frequency of pulsation generated in the pipe based on an actual rotational speed of the electric compressor,
calculate an air column resonance frequency of the pipe based on a sonic speed of the refrigerant and a length of the pipe, and
when the pulsation frequency coincides with the air column resonance frequency or is within a predetermined frequency band including the air column resonance frequency, update the target rotational speed for the electric compressor based on an air conditioning request so as to avoid the pulsation frequency coinciding with the air column resonance frequency or being within the frequency band.
